(19) United States
(12) Patent Application Publication
(10) Pub. No.: US 2026/0001388 A1
(43) Pub. Date: Jan. 1, 2026

(54) WINDOW REGULATOR SLIDER ASSEMBLY FOR A FRAMELESS VEHICLE DOOR

(71) Applicant: HI-LEX CONTROLS INCORPORATED, Rochester Hills, MI (US)

(72) Inventor: SHIGEKI ARIMOTO, Bloomfield Hills, MI (US)

(73) Assignee: HI-LEX CONTROLS INCORPORATED, Rochester Hills, MI (US)

(21) Appl. No.: 19/319,806

(22) Filed: Sep. 5, 2025

(51) Int. Cl. B60J 1/00; B60J 1/17

(52) U.S. Cl. CPC B60J 1/006; B60J 1/17

(57) ABSTRACT

A window regulator slider assembly for a frameless vehicle door is disclosed. The assembly includes a slider base configured to traverse along at least one guide rail, and an inside glass retainer coupled to the slider base, and an outside glass retainer positioned opposite the inside glass retainer to clamp either a side-glass pane or a glass holder bracket affixed to the side-glass pane between them. The inside glass retainer includes one or more resilient spring tabs configured to engage either the lower edge of a side-glass pane or a glass holder bracket bonded to the side-glass pane. The spring tabs are arranged in fore-side and aft-side tab groups, with the fore-side tab group providing vertical constraint in a downward direction, and the aft-side tab group providing fore-aft and vertical constraints. Each spring tab is shaped to engage with corresponding contours along the lower edge of the side-glass pane or the glass holder bracket, enabling accurate initial positioning and minimizing post-installation adjustment.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The present disclosure relates to vehicle window systems, and more particularly to a window regulator slider assembly configured for use in frameless vehicle doors, wherein the slider assembly facilitates positioning and support of a side-glass pane during installation and operation.

### BACKGROUND

Modern vehicles, especially those with frameless door designs, often utilize window regulator systems that include slider assemblies mounted within the door structure. These systems support and guide the vertical movement of the side-glass pane along guide rails. The glass is typically secured to a glass retainer or lift plate through mounting holes formed near its bottom edge.

To facilitate alignment during installation, these holes are commonly oversized. While this design enables post-installation adjustment of the glass position, it also introduces challenges in accurately and efficiently positioning the glass during initial assembly. As a result, assembly technicians may need to spend additional time manually aligning the glass to achieve proper sealing and fit relative to the vehicle body, particularly in frameless door configurations where precise positioning is critical.

Existing systems often include adjustable lift plates, sliders, or retention mechanisms that allow limited repositioning of the glass pane in vertical or fore-aft directions. These solutions typically involve the use of mechanical fasteners such as bolts, clamps, or cam-based systems. However, such systems generally require manual adjustment after the glass has been installed and do not include built-in locating features to assist with initial positioning.

Challenges remain in improving the consistency and efficiency of side-glass installation, particularly in frameless door assemblies where tight tolerances and precise alignment are required to meet aesthetic and performance expectations.

In light of the aforementioned discussion, there exists a need for an assembly that addresses the identified challenges associated with existing systems and enables improved alignment and installation of side-glass panes, particularly in frameless door configurations.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards window regulator slider assembly for a frameless vehicle door.

An objective of the present disclosure is directed towards providing a window regulator slider assembly for frameless doors that enables accurate initial positioning of the side-glass pane during assembly.

Another objective of the present disclosure is directed towards reducing the time and effort required during glass installation by incorporating built-in locating features that automatically guide the glass toward a nominal position.

Another objective of the present disclosure is directed towards improving the consistency and repeatability of glass alignment in production environments by minimizing reliance on manual adjustment.

Another objective of the present disclosure is directed towards accommodating manufacturing tolerances while still allowing for controlled post-installation adjustments in multiple directions, including downward, fore/aft.

Another objective of the present disclosure is directed towards integrating flexible support features, such as resilient spring tabs, into the glass retainer structure to simplify assembly without the need for additional tools or fixtures.

Another objective of the present disclosure is directed towards providing a coordinated locating scheme using differentiated constraints at the aft side (three-way) and fore side (one-way) of the glass to optimize support and adjustability.

According to an exemplary aspect of the present disclosure, a window regulator slider assembly for a frameless vehicle door.

According to another exemplary aspect of the present disclosure, the assembly being mounted within the frameless vehicle door and configured to carry a side-glass pane.

According to another exemplary aspect of the present disclosure, a slider base positioned within the frameless vehicle door, the slider base configured to traverse along at least one guide rail.

According to another exemplary aspect of the present disclosure, an inside glass retainer coupled to the slider base, the inside glass retainer configured to directly engage a lower edge of the side-glass pane.

According to another exemplary aspect of the present disclosure, an outside glass retainer positioned opposite the inside glass retainer, the side-glass pane being clamped between the inside and outside glass retainers.

According to another exemplary aspect of the present disclosure, one or more resilient spring tabs protruding from the inside glass retainer, the one or more resilient spring tabs comprising a fore-side tab group configured to provide one-way vertical constraint for the side-glass pane in an downward direction.

According to another exemplary aspect of the present disclosure, an aft-side tab group configured to provide three-way constraint for the side-glass pane in both fore-aft and downward directions.

According to another exemplary aspect of the present disclosure, each spring tab is configured to engage a corresponding contour along the lower edge of the side-glass pane to establish initial positioning of the side-glass pane, thereby minimizing post-installation adjustment work.

According to another exemplary aspect of the present disclosure, a window regulator slider assembly for a frameless vehicle door.

According to another exemplary aspect of the present disclosure, the assembly being mounted within the frameless vehicle door and configured to carry a side-glass pane includes a slider base positioned within the frameless vehicle door, the slider base configured to traverse along at least one guide rail.

According to another exemplary aspect of the present disclosure, a inside glass retainer coupled to the slider base, the inside glass retainer configured to engage a glass holder bracket assembled on the side-glass pane.

According to another exemplary aspect of the present disclosure, an outside glass retainer positioned opposite the inside glass retainer, the glass holder bracket being clamped between the inside and outside glass retainers.

According to another exemplary aspect of the present disclosure, one or more resilient spring tabs protruding from the inside glass retainer, the one or more resilient spring tabs comprising a fore-side tab group configured to provide one-way vertical constraint for the side-glass pane with glass holder bracket in downward direction.

According to another exemplary aspect of the present disclosure, an aft-side tab group configured to provide three-way constraint for the side-glass pane with glass holder bracket in both fore-aft and downward directions.

According to another exemplary aspect of the present disclosure, each spring tab is configured to engage a corresponding contour along the glass holder bracket to establish initial positioning of the side-glass pane, thereby minimizing post-installation adjustment work.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is an example diagram depicting window regulator slider assembly for a frameless vehicle door, in accordance with one or more exemplary embodiments.

FIG. 2 is an example diagram depicting the aft-side slider assembly, in accordance with one or more exemplary embodiments.

FIG. 3 is an example diagram depicting the fore-side slider assembly, in accordance with one or more exemplary embodiments.

FIG. 4 is an example diagram depicting an exploded view of an aft-side slider assembly of a window regulator, in accordance with one or more exemplary embodiments.

FIG. 5 is an example diagram depicting various positional adjustment states of a side-glass pane relative to the slider assembly during installation or alignment, in accordance with one or more exemplary embodiments.

FIG. 6 is an example diagram depicting a side-glass pane with glass holder brackets attached to its lower edge, in accordance with one or more exemplary embodiments.

Furthermore, the objects and advantages of this invention will become apparent from the following description and the accompanying annexed drawings.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

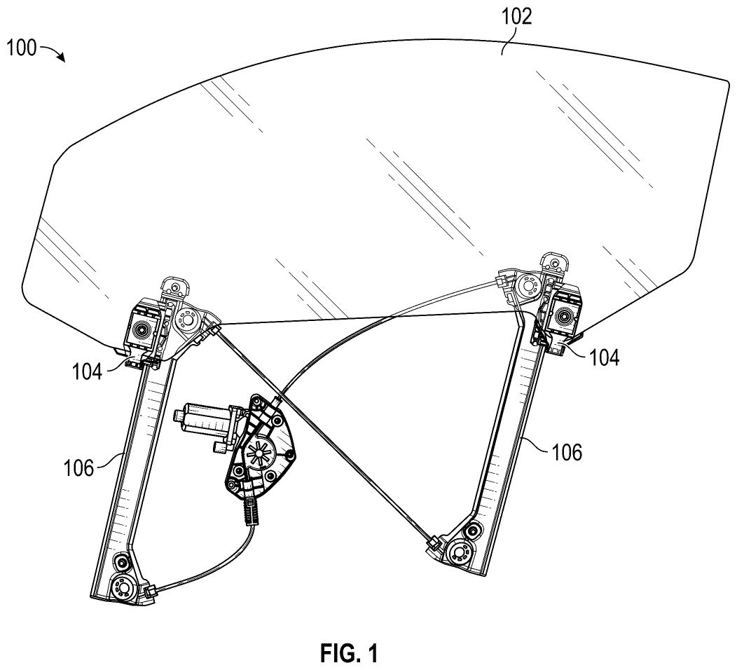

Referring to FIG. 1, an example diagram depicts window regulator slider assembly for a frameless vehicle door, in accordance with one or more exemplary embodiments. The window regulator 100 includes a side-glass pane 102, a pair of slider assemblies 104, and a pair of guide rails 106. The slider assemblies 104 are mounted within the frameless door and positioned on opposing (fore and aft) sides of the side-glass pane 102. Each slider assembly 104 is mounted to a respective vertical guide rail 106 and operatively connected to a cable-driven window regulator mechanism.

The side-glass pane 102 is supported between the slider assemblies 104, which guide its vertical movement along the guide rails 106 during actuation. Additionally, the slider assemblies 104 assist in temporary alignment of the glass pane 102 during installation. In one embodiment, the aft-side slider assembly provides constraint in both the fore-aft and downward directions, while the fore-side slider assembly constrains the glass in the downward direction.

The window regulator 100 ensures smooth and stable operation of the side-glass pane 102 through coordinated movement of the slider assemblies 104. The slider assemblies 104 are suitable for use with an electrically actuated window regulator and is particularly advantageous for frameless door applications, where precise positioning of the glass is essential for effective sealing and operation.

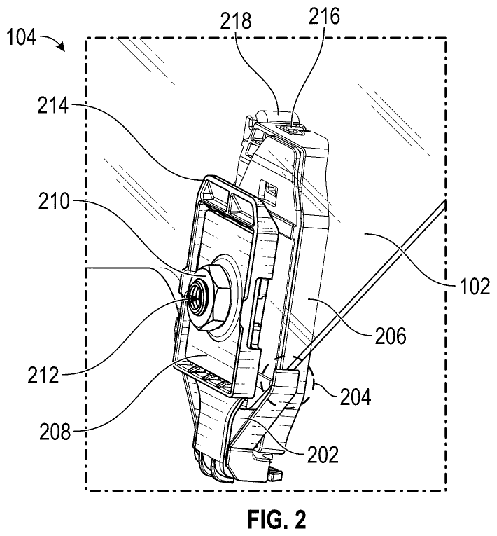

Referring to FIG. 2, an example diagram depicts the aft-side slider assembly 104, in accordance with one or more exemplary embodiments. The figure illustrates how the slider assembly 104 engages and supports a lower edge region of the side-glass pane 102 during installation within a frameless vehicle door.

The slider assembly 104 includes an inside glass retainer 202, a set of resilient spring tabs 204, a slider base 206, a back plate 208, a flat nut 210, and a double-threaded insert screw 212, an outside glass retainer 214, a slider insert 216, and cushion rubbers 218. The inside glass retainer 202 is coupled to the slider base 206 and is configured to engage directly with the lower edge of the side-glass pane 102, providing structural support and contributing to its preliminary positioning. The set of resilient spring tabs 204 project upward from the inside glass retainer 202 and are shaped to interface with corresponding contours on the glass edge.

The cooperative interaction between the spring tabs 204 and the shaped edge of the glass temporarily stabilizes the side-glass pane 102 within the slider assembly 104 prior to final fastening. The resilient spring tabs 204 are elastically deflectable, thereby enabling controlled post-installation adjustment of the side-glass pane 102 to accommodate manufacturing tolerances and achieve the desired final alignment. The outside glass retainer 214, the back plate 208, the flat nut 210, and double-threaded insert screw 212 form part of the fastening mechanism that secures the glass to the slider assembly. The slider insert 216 is coupled to the slider base 206 and configured to contact a guide rail (As shown in FIG. 1) and the cushion rubbers 218 are coupled to the slider base 206 and configured to contact to the guide rail 106 to dampen impact force and reduce noise and mechanical stress. This ensures precise alignment in frameless door applications where accurate positioning is critical for sealing and operational performance.

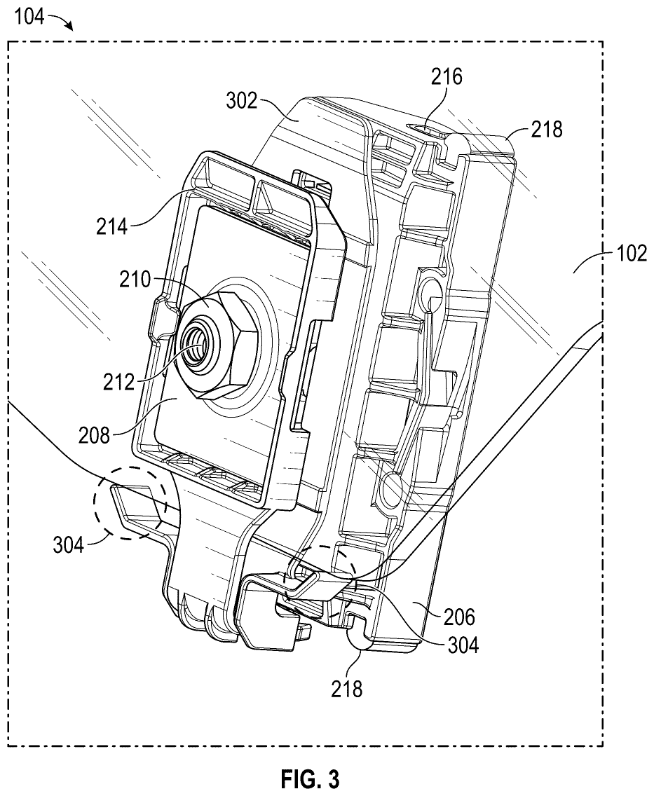

Referring to FIG. 3, an example diagram depicts the fore-side slider assembly, in accordance with one or more exemplary embodiments. The diagram illustrates how the slider assembly engages the side-glass pane 102 during installation.

The slider assembly 104 is mounted to the guide rail 106. The slider assembly 104 is coupled to a slider base 206 and includes an inside glass retainer 302 integrated with a set of spring tabs 304. The inside glass retainer 302 is positioned adjacent to the lower edge of the side-glass pane 102 and is configured to support and temporarily locate the glass within the slider assembly 104. An outside glass retainer 214 is positioned opposite the inside glass retainer 202, with a back plate 208 and flat nut 210 cooperating with a double-threaded insert screw 212 to clamp the glass retainers together. A slider insert 216 is coupled to the slider base 206 and configured to contact a guide rail (As shown in FIG. 1), and the cushion rubbers 218 are coupled to the slider base 206 and configured to contact to the guide rail 106 to dampen impact force and reduce noise and mechanical stress. The spring tabs 304 protrude from the inside glass retainer 302 toward the surface of the side-glass pane 102 and are shaped to engage corresponding edge regions of the glass.

In this configuration, the spring tabs 304 are adapted to provide one-way positional constraint in the downward direction only. The resilient nature of the spring tabs 304 permits limited vertical displacement of the side-glass pane 102, thereby accommodating dimensional variations between the mounting holes in the glass and the guide rails. This arrangement enables the glass to be positioned close to its nominal location during initial assembly, while allowing for controlled vertical adjustment as needed.

In one embodiment, a pair of spring tab groups extend from the inside glass retainer 202: an aft-side tab group including spring tabs 204, configured to provide three-way constraint in both the fore-aft and downward directions; a pair of spring tab groups extend from the inside glass retainer 302: a fore-side tab group including spring tabs 304, configured to provide one-way constraint in the downward direction. Each spring tab is shaped and oriented to engage a complementary contour on the lower edge of the side-glass pane 102, thereby facilitating precise initial alignment and reducing the need for post-installation adjustments.

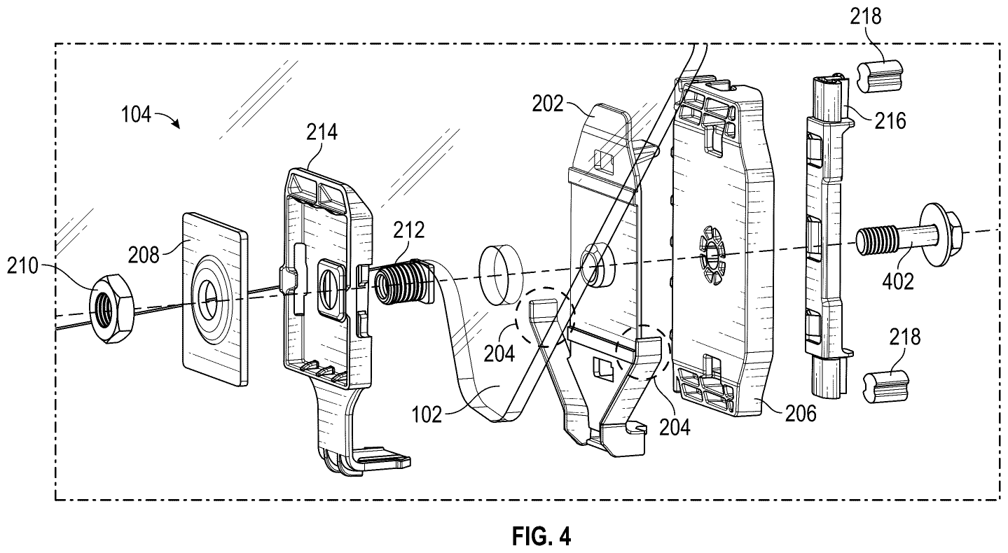

Referring to FIG. 4, an example diagram depicts an exploded view of an aft-side slider assembly 104 of a window regulator, in accordance with one or more exemplary embodiments. The slider assembly 104 is configured to support and accurately position the side-glass pane 102, particularly in frameless vehicle door applications. The assembly includes a side-glass pane 102, an inside glass retainer 202, resilient spring tabs 204, a slider base 206, a back plate 208, a flat nut 210, a double threaded screw 212, an outside glass retainer 214, a slider insert 216, and cushion rubbers 218, and a glass attachment bolt 402.

The slider base 206 forms the primary structural body and is configured to traverse along a guide rail of the window regulator. An inside glass retainer202 is attached to the slider base 206, with the side-glass pane 102 positioned between the inside glass retainer 202 and outside glass retainer 214. Each glass retainer 202 and 214 is configured to contact either the side-glass pane 102 or an attached glass holder bracket. The inside glass retainer 202 includes integrated resilient spring tabs 204, which extend toward the lower edge of the side-glass pane 102 and are shaped to engage complementary contours along either the lower edge of the side-glass pane 102 or an attached glass holder bracket. These spring tabs 204 provide initial positioning and constraint in the fore-aft and downward directions during installation.

The double threaded screw 212 extends through the outside glass retainer 214, forming in a shape that prevents it from rotating relative to the outside glass retainer 214. The external thread of the double threaded screw 212 engages with the back plate 208 and flat nut 210 to be secured on the outside glass retainer 214. The internal thread of the double threaded screw 212 engages with the glass attachment bolt 402, and tightening the glass attachment bolt 402 clamps the side-glass pane 102 securely between the inside glass retainer 202 and outside glass retainer 214. The post installation adjustment can be done by loosing either the glass attachment bot 402 or flat nut 210 to unclamp the side-glass pane 102.

The cushion rubbers 218 and the slider insert 216 are assembled on the slider base 206 The cushion rubbers 218 dampen impact force, reduce noise, and reduce mechanical stress on the window regulator system during window regulator operation. The slider insert 216 contacts and slides against the surface of the guide rail 106 and is made of low-friction polymer.

This integrated fastening and alignment structure enables precise in-out positioning through the glass attachment bolt 402, while the spring tabs 204 temporarily locate the glass in the fore-aft and downward directions before final clamping. Such an arrangement facilitates efficient installation, reduces post-installation adjustments, and ensures reliable sealing performance in frameless door applications.

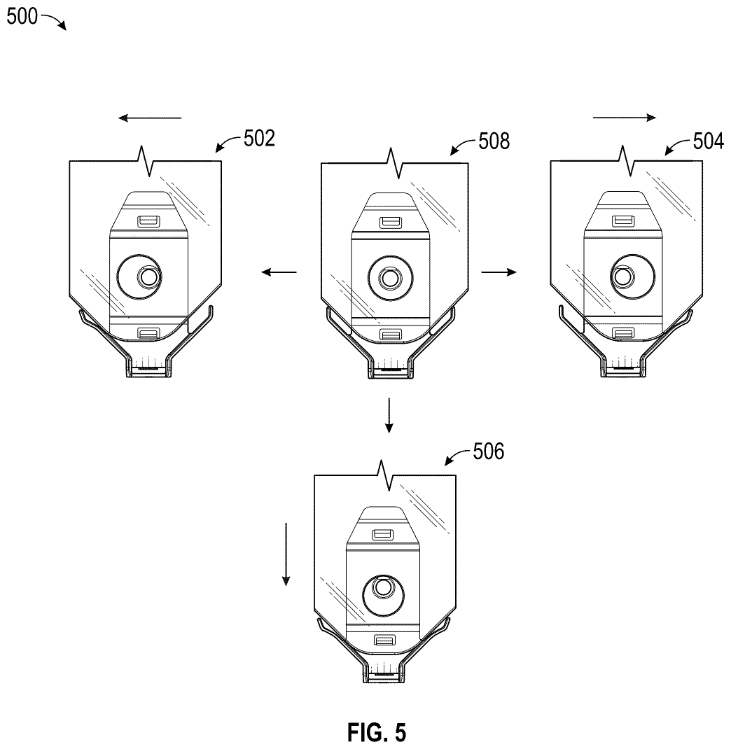

Referring to FIG. 5, an example diagram 500 depicts various positional adjustment states of a side-glass pane 102 relative to the slider assembly during installation or alignment, in accordance with one or more exemplary embodiments. The diagram presents a sequence of displacement conditions that the glass may undergo prior to final fastening.

In one condition, 502 shows displacement toward the fore direction (leftward), while reference 504 shows displacement toward the aft direction (rightward), demonstrating the fore-aft adjustment functionality provided by the slider assembly. Reference 506 illustrates downward vertical displacement, allowing for adjustment in the opposite vertical direction. Reference 508 represents the glass in a nominal or centered position relative to the slider assembly, which corresponds to the desired alignment prior to final tightening of the glass attachment components. This configuration enables temporary yet controlled positioning of the side-glass pane 102 within defined tolerances, thereby facilitating efficient and repeatable alignment during installation in frameless door systems.

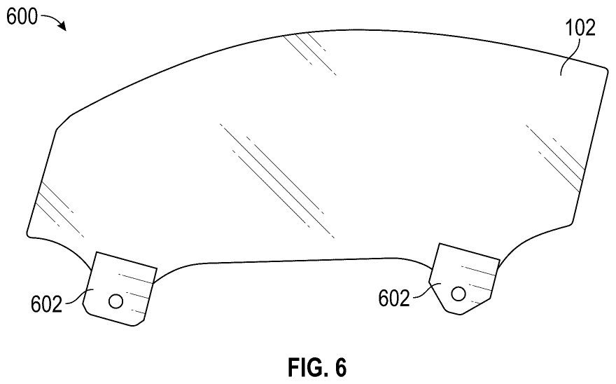

Referring to FIG. 6, an example diagram 600 depicts a side-glass pane 102 with a pair of glass holder brackets 602 attached to its lower edge, in accordance with one or more exemplary embodiments. These glass holder brackets 602 are typically bonded or glued onto the glass surface rather than inserted through holes, which makes the configuration suitable for laminated glass applications where drilling is not permissible or desired.

Each glass holder bracket 602 serves as an attachment interface between the side-glass pane 102 and the window regulator slider assembly (As shown in the FIG. 1). The glass holder brackets 602 include a mounting hole to accommodate a fastening mechanism such as a bolt. During installation, these glass holder brackets 602 facilitate mechanical clamping of the glass by allowing the slider assembly to engage the glass indirectly through the brackets without requiring any physical penetration of the glass itself.

This bracket-based attachment configuration facilitates integration with laminated or coated glass panes used in automotive doors. It supports secure mechanical attachment while preserving the integrity of the glass and enabling compliance with safety and acoustic performance requirements.

In one embodiment, the inside glass retainer (As shown in FIG. 2, FIG. 3) of the slider assembly is configured to engage a glass holder bracket 602 made of plastic or metal and preassembled on the bottom edge of the side-glass pane.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A window regulator slider assembly for a frameless vehicle door, the assembly being mounted within the frameless vehicle door and configured to carry a side-glass pane, comprising:
a slider base positioned within the frameless vehicle door, the slider base configured to traverse along at least one guide rail;
an inside glass retainer coupled to the slider base, the inside glass retainer configured to directly engage a lower edge of the side-glass pane;
an outside glass retainer positioned opposite the inside glass retainer, the side-glass pane being clamped between the inside and outside glass retainers;
one or more resilient spring tabs protruding from the inside glass retainer, the one or more resilient spring tabs comprising a fore-side tab group configured to provide one-way vertical constraint for the side-glass pane in a downward direction; and
an aft-side tab group configured to provide three-way constraint for the side-glass pane in both fore-aft and downward directions, wherein each spring tab is configured to engage a corresponding contour along the lower edge of the side-glass pane to establish initial positioning, thereby minimizing post-installation adjustment work.

2. The window regulator slider assembly of claim 1, wherein the one or more resilient spring tabs are elastically deflectable, thereby enabling controlled post-installation adjustment of the side-glass pane.

3. The window regulator slider assembly of claim 1, wherein the shape of the lower edge of the side-glass pane is correlated to the locating features on the inside glass retainer to facilitate support of the glass in three-way and one-way directions.

4. The window regulator slider assembly of claim 1, wherein the inside glass retainer and outside glass retainer are configured to clamp the side-glass pane without penetrating the glass.

5. A window regulator slider assembly for a frameless vehicle door, the assembly being mounted within the frameless vehicle door and configured to carry a side-glass pane, comprising:
a slider base positioned within the frameless vehicle door, the slider base configured to traverse along at least one guide rail;
an inside glass retainer coupled to the slider base, the inside glass retainer configured to engage the glass holder bracket assembled on the side-glass pane;
an outside glass retainer positioned opposite the inside glass retainer, the glass holder bracket being clamped between the inside and outside glass retainers;
one or more resilient spring tabs protruding from the inside glass retainer, the one or more resilient spring tabs comprising: a fore-side tab group configured to provide one-way vertical constraint for the side-glass pane in a downward direction; and
an aft-side tab group configured to provide three-way constraint for the side-glass pane in both fore-aft and downward directions, wherein each spring tab is configured to engage a corresponding contour along the glass holder bracket to establish initial positioning, thereby minimizing post-installation adjustment work.
